(19) United States
(12) Patent Application Publication
(10) Pub. No.: US 2007/0224359 A1
(43) Pub. Date: Sep. 27, 2007

(54) Method for preparing strain tolerant coatings by a sol-gel process

(76) Inventors: David Leslie Burin, Greer, SC (US); Paul DiMascio, Greer, SC (US); Matthew O'Connell, Simpsonville, SC (US)

Correspondence Address: CANTOR COLBURN, LLP, 55 GRIFFIN ROAD SOUTH, BLOOMFIELD, CT, 06002, US

(21) Appl. No.: 11/386,424

(22) Filed: Mar. 22, 2006

(51) Int. Cl. B05D 3/02; B05D 1/36

(52) U.S. Cl. 427/419.2; 427/372.2

(57) ABSTRACT

Methods for coating metal substrates are provided. The coating comprises a strain tolerant coating using a sol-gel process, and articles made therefrom. In one embodiment, the method of coating a metal substrate comprises: disposing a sol coating on a metal substrate; inducing the sol coating to convert to a gel coating; inducing a pattern on or in the gel coating; and sintering the gel coating.

### BACKGROUND OF THE INVENTION

Disclosed herein are methods for preparing strain tolerant coatings. In particular, to a method for preparing strain tolerant coatings to be applied to substrates. In further detail, methods are disclosed for preparing strain tolerant coatings for thermal barrier coatings.

When exposed to high temperatures (i.e., greater than or equal to about 704° C.) and to oxidative environments, metals can oxidize, corrode, and become brittle. Environments such as these are produced in gas turbines used for power generation applications. A thermal barrier coating (TBC), when applied to metal turbine components, can reduce the effects that high-temperature, oxidative environments have on the metal components.

Thermal barrier coatings are typically comprised of two components, a metallic bond coating and a ceramic coating. The metallic bond coating can contain oxidation protection and or corrosion protection materials such as aluminum and chromium. For example, the metallic bond coating can comprise chromium, aluminum, yttrium, or combinations of the forgoing, such as MCrAlY where M is nickel, cobalt, or iron (U.S. Pat. No. 4,034,142 to Hecht, and U.S. Pat. No. 4,585,481 to Gupta et al. describe some coating materials). These metallic bond coatings can be applied by thermal spraying techniques (Gupta et al. describe the coating materials comprising silicon and hafnium particles being applied by plasma spraying).

The ceramic coating of the thermal barrier coating can be applied to the metallic bond coating by known methods such as air plasma spray (APS) or electron beam physical vapor deposition (EB-PVD).

Traditional coating methods to obtain a strain tolerant TBC can be very expensive and/or very difficult to produce. Coatings produced through the EB-PVD method produce a structure, which is very strain tolerant, yet the process is expensive and can be impractical, especially for components that have large or unique geometries. Hence, there exists a need for an improved method to apply a strain tolerant TBC to metal turbine components and other structures that could benefit from the presence of a TBC.

### SUMMARY OF THE INVENTION

Disclosed herein are methods for coating metal substrates with a strain tolerant coating using a sol-gel process; and articles made therefrom. In one embodiment, a method of coating a metal substrate with a strain tolerant coating comprises disposing a sol coating on a metal substrate; inducing the sol coating to convert to a gel coating; inducing a pattern on or in the gel coating; and sintering the gel coating to form a strain tolerant coating.

In another embodiment, a method for coating a metal substrate comprises disposing a metallic bond coating on a metal substrate; disposing a sol coating on the metallic bond coating to the surface opposite to the metal substrate; inducing the sol coating to convert to a gel coating; inducing a pattern on or in the gel coating to form a patterned gel coating; hot-isostatically pressing the patterned gel coating; and sintering the gel coating to form a strain tolerant coating.

The above described and other features are exemplified by the following detailed description.

### DETAILED DESCRIPTION

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc).

Disclosed herein are processes for producing strain tolerant coatings using a sol-gel type process. The processes for producing strain tolerant coatings using a sol-gel type process can be used to produce thermal barrier coatings. Such a process allows for the convenient preparation of coated articles having intricate and large geometries, such as turbine components, as the thermal barrier coatings can be applied using techniques such as dip coating, spray coating, roll coating, inkjet printing, spin coating, painting, and the like. The following description will be directed to the coating and the process with respect to a thermal barrier coating; however, this application of the coating and process is merely exemplary and is not intended to limit the invention in any manner. The coating and process can be used to apply a coating to any suitable substrate for any appropriate application.

Generally, the method of preparing the strain tolerant thermal barrier coating on a metal substrate comprises the following: disposing a sol coating on a metal substrate; inducing the sol coating to convert to a gel coating; inducing a pattern on or in the gel coating; and sintering the gel coating to form a strain tolerant coating.

More specifically, the method comprises disposing a metallic bond coating on the metal substrate; disposing a sol coating on the metallic bond coating to the surface opposite to the metal substrate; inducing the sol coating to convert to a gel coating; inducing a pattern on or in the gel coating; and sintering the gel coating to form a strain tolerant thermal barrier coating. The resulting coating provides oxidation protection to the metallic bond coating and the substrate.

The sol-gel process involves the transition of a system from a liquid phase (colloidal “sol”) into a solid phase (“gel”). Sols typically are suspensions or dispersions of discrete solid particles, having a size of about 1 to about 1000 nanometers, in a liquid phase. The sol may be prepared by known methods such as dispersion or condensation methods. Condensation or precipitation methods work by making the colloidal particle come out of solution into the colloidal phase, for example, by adding a precipitating agent or by changing the temperature. In a typical condensation sol-gel process, the precursor is subjected to a series of hydrolysis and polymerization reactions to form a colloidal suspension. Then the particles condense into a solid phase, the gel. The stability of sols may be maintained by using dispersing agents.

Sols are known in the art and can be prepared from a variety of processes and starting materials. The sol coating can be an organic polymer suspension loaded with inorganic powders. Once the sol is applied to the substrate, polymerization is induced to result in a network gel. Exemplary polymer suspensions include those sols formed from metal alkoxide precursors via hydrolysis reactions, wherein upon dehydration the gel is formed. Specific metal alkoxide precursors suitable for use to prepare the sol include, for example, M(OR¹ₙ)R²₄₋ₙ where M is Si, Ti, Zr, and the like; R¹ is a lower alkyl group; R² is a lower alkyl group or a phenyl group optionally substituted with one or more lower alkyl groups; and n is 1, 2, 3, or 4. As used herein, lower alkyl group includes straight alkyl groups having from 1 to about 10 carbon atoms, branched alkyl groups having from 3 to about 10 carbon atoms, or cyclic alkyl groups having from 3 to about 10 carbon atoms. Exemplary lower alkyl groups include methyl, ethyl, n-propyl, isopropyl, cyclopropyl, n-butyl, sec-butyl, tert-butyl, cyclobutyl, n-pentyl, isopentyl, cyclopentyl, n-hexyl, cyclohexyl, n-heptyl, and the like.

The desired metal alkoxides are mixed in a suitable solvent, such as an alkyl alcohol, and optionally water. A condensation catalyst may also be added to the sol. An exemplary sol includes one prepared from a solution of a metal alkoxide, e.g. zirconium tetra-n-propoxide or tetra-isopropoxide, in an alcohol, specifically n-propanol or isopropanol, with the optional addition of water and/or an inorganic or organic acid used as a condensation catalyst. Exemplary condensation catalysts include hydrochloric acid or acetic acid.

The gel state can then be produced by the removal of water and other volatile components from the sol. The drying of the sol can be carried out at a temperature which is greater than ambient room temperature and less than 350° C., specifically less than 250° C. In one embodiment, air or inert gas at a temperature of less than 350° C. can be blown on the sol coating to effect drying. Such a sol-gel process is disclosed in U.S. Pat. No. 6,898,259. Similar sols are described in U.S. Pat. No. 5,585,136.

Other suitable sols include the hydrated oxide sols disclosed in U.S. Pat. No. 5,091,348. Exemplary sols include hydrated oxide sols of zirconium (IV), indium (III), gallium (III), iron (III), aluminum (III), chromium (III), cerium (IV), silicon (IV), titanium (IV), and combinations comprising at least one of the foregoing. Stabilizers can be included such as yttrium (Y), cerium (Ce), barium (Ba), lanthanum (La), magnesium (Mg), scandium (Sc), calcium (Ca), and so forth, oxides comprising at least one of the foregoing, as well as combinations comprising at least one of the foregoing, such as yttria-stabilized zirconia. The sols can be dehydrated to form a homogeneous gel, and then sintered to form the desired ceramic material. These sols, as well as those prepared by the condensation method, can optionally further include a salt or oxide of at least one metal selected from the group consisting of Al, Pb, Ca, Sr, Ba, La, Rb, Ag, Au, Cd, Na, Mg, Li, K, Sc, V, Cr, Mn, Fe, Co, Y, Nb, In, Hf, Ta, W, Ce, Pr, Nd, Sm, Eu, Gd, Tb, Dy, Ho, Er, Tm, Yb, Lu, Th, U, Ni, Cu, Zn, As, Ga, Ge, Ru, Sn and combinations comprising at least one of the foregoing. Specifically, metal oxides or metal salts can be added to impart the resulting sintered coating with corrosion resistance and other desirable properties.

The hydrated oxide sols can then be dehydrated to form a homogeneous gel. Dehydration can be effected by use of a non-aqueous solvent or by evaporation of water, under conditions such that the gel is homogeneous.

Additives may be added to control the viscosity and surface tension of the sol to improve its stability and provide convenient processing of the sol to coat the substrate. The sol may be coated on the substrate using any number of techniques, for example, dip coating, spray coating, roll coating, inkjet printing, spin coating, painting. The thickness of the coating can be made using successive coating techniques or by the faster removal of a dipped component from a sol.

The sol coating is then induced to polymerize into a network gel to form a gel coating. Methods to induce the formation of the gel include drying or dehydrating the sol as previously described.

The thickness of the resulting gel coating can be up to about 600 micrometers or more, specifically about 1 to about 500 micrometers, and more specifically about 250 to about 400 micrometers.

In one embodiment, to minimize the potential of cracks forming in the final coating, the gel coating can undergo a hot-isostatic pressing process prior to, or during, the sintering step. Such a step allows for thicker coatings to be dried and sintered without uncontrolled or undesired cracking.

Once the gel coating has formed, a pattern can be induced on or in the gel coating to result in a strain tolerant coating once sintered. As used herein, “inducing a pattern” means altering the surface morphology and structure of the gel coating to result in a pattern that results in a strain tolerant coating upon sintering the gel. The process of inducing a pattern is not particularly limited and can be selected by one of ordinary skill in the art without undue experimentation using the guidelines provided. The process of inducing a pattern may be provided by various mechanical, chemical, or thermal methods. Mechanical methods can include means such as scratching, imprinting, screening, cutting, or utilizing a peelable mesh that would inhibit coating in desired locations on the substrate and be physically removed after the coating process is complete or burned out during the sintering process. Imprinting can include pressing a mold to the surface of the gel to impart a pattern, where the mold contains a negative of the desired pattern. Chemical means can include methods such as application of a non-wetting pattern or inclusion of a specialized binder, which would crack predictably during the drying and/or sintering steps. Thermal modification can be achieved using means such as a laser or electronbeam (EB) etching. The resulting pattern, regardless of the method by which it is achieved will allow the resulting coating to better tolerate thermal expansion changes of the coated components.

The resulting gel coating can be heated to remove free and bound water as well as any remaining volatile components that may be present.

The gel coating induced with a pattern can be subjected to a sintering step to burn off any remaining organic polymer components leaving a coating of inorganic material disposed on the surface of the substrate or metallic bond coating. The sintering step can be performed using a low temperature firing process. Such a process includes sintering the gel coating at temperatures of about 750° C. to about 1800° C., specifically about 900° C. to about 1150° C., more specifically about 1000° C. to about 1100° C., and yet more specifically about 1050° C. to about 1075° C.

The density of the sintered coating may be controlled by the amount of organic binders present in the sol-gel, as well as the temperature and time of the sintering process.

The metal substrate can be any one of various components that would benefit from the addition of a barrier coating, such as, for example, combustion liners or transition pieces, buckets, nozzles, blades, vanes, shrouds, as well as other components, for example, components that will be disposed in a hot gas stream in a turbine engine. This metal substrate can comprise various metals employed in such applications including nickel, cobalt, iron, combinations comprising at least one of the foregoing, as well as alloys comprising at least one of the foregoing, such as a nickel-base superalloy, and/or a cobalt-based superalloy.

The metallic bond coating material(s) to form the barrier coatings can include nickel (Ni), cobalt (Co), iron (Fe), chromium (Cr), aluminum (Al), yttrium (Y), alloys comprising at least one of the foregoing, as well as combinations comprising at least one of the foregoing, e.g., the metallic bond coating can comprises MCrAlY (where M consists of nickel, cobalt, iron, and combinations comprising at least one of the forgoing). An MCrAlY coating can further comprise elements such as silicon (Si), ruthenium (Ru), iridium (Ir), osmium (Os), gold (Au), silver (Ag), tantalum (Ta), palladium (Pd), rhenium (Re), hafnium (Hf), platinum (Pt), rhodium (Rh), tungsten (W), alloys comprising at least one of the foregoing, as well as combinations comprising at least one of the foregoing. For example, the metallic bond coat can comprise sufficient aluminum to form an alumina scale on the surface of the metallic bond coating. The aluminum can be in the form of an aluminide that optionally comprises ruthenium (Ru), iridium (Ir), osmium (Os), gold (Au), silver (Ag), palladium (Pd), platinum (Pt), rhodium (Rh), alloys comprising at least one of the foregoing, as well as combinations comprising at least one of the foregoing.

Application of the metallic bond coating to the substrate, which can be accomplished in a single or multiple stages, can be accomplished in various fashions, including vapor deposition (e.g., electron beam physical vapor deposition (EB-PVD), chemical vapor deposition (CVD), and so forth), electroplating, ion plasma deposition (IPD), plasma spray (e.g., vacuum plasma spray (VPS), low pressure plasma spray (LPPS), air plasma spray (APS), and so forth), thermal deposition (e.g., high velocity oxidation fuel (HVOF) deposition, and so forth), as well as combinations comprising at least one of the foregoing processes. For example, metallic bond coating components can be combined (e.g., by induction melting, and so forth), powderized (e.g., by powder atomization), a plasma sprayed onto the substrate. Alternatively, or in addition, the metallic bond coating elements can be incorporated into a target and ion plasma deposited. Where multiple stages are employed, the same or different elements can be applied to the substrate during each phase. As an example, a precious metal (e.g., platinum) can be applied by a technique that reduces waste, followed by another process to apply the remaining elements. Therefore, the precious metal can be electroplated onto the substrate surface, and the other elements can be applied by the thermal deposition (e.g., by HVOF) of a powder composition. Aluminiding can then be carried out, e.g., to attain intermixing of the precious metal with the rest of the coating composition.

For example, metal material (e.g., in the form of wire, rod, and so forth) can be applied to a substrate. The metal material can be feed fed into an oxy-acetylene flame. The flame melts the metal material and atomizes the particle melt with an auxiliary stream of high-pressure air that deposits the material as a coating on the substrate. Flameless spray apparatus can also be employed, such as those disclosed in U.S. Pat. No. 5,285,967 to Weidman. The HVOF process produces smooth coatings, e.g., a coating having a Rₐ of less than or equal to about 1 micrometer (50 microinches).

The thickness of the metallic bond coating depends upon the application in which the coated component is used and the application technique. The coating can be applied to turbine components at a thickness of about 50 micrometers to about 625 micrometers, or, more specifically, about 75 micrometers to about 425 micrometers. The metallic bond coating can be treated to roughen the surface prior to the application of the sol-gel coating. Specifically the metallic bond coating can be roughened in the order of about 100 to about 400 microinches (about 2.54 to about 10.16 micrometers) surface roughness average (Ra) to provide adequate bonding for the application of the sol-gel coating.

In an exemplary embodiment, a metal substrate is coated with a strain tolerant TBC using a sol-gel type process. A metal substrate is first coated with a metallic bond coating by any number of processes including, for example, HVOF or VPS. A sol containing inorganic metal oxide powders is then coated on the metallic bond coating to the surface opposite to the metal substrate. The sol coating is induced to form a gel coating by removal of the liquid and other volatile components of the sol. The resulting polymerization or curing of the sol results in a gel coating. The resulting gel coating is induced with a strain tolerant pattern, such as a cross-hatch pattern, to provide strain tolerance in the final article. This strain tolerance inhibits the formation and propagation of cracking and spallation of the coating during an engine service interval of a turbine engine component for example. The final step includes sintering the patterned gel coating to form a strain tolerant TBC on the metal substrate.

Also provided herein is a coating prepared by the process comprising disposing a sol coating on a metal substrate; inducing the sol coating to convert to a gel coating; inducing a pattern on or in the gel coating; and sintering the gel coating to form a strain tolerant coating. Specifically, the coating is prepared by the process comprising disposing a metallic bond coating on a metal substrate; disposing a sol coating on the metallic bond coating to the surface opposite to the metal substrate; inducing the sol coating to convert to a gel coating; inducing a pattern on or in the gel coating to form a patterned gel coating; hot-isostatically pressing the patterned gel coating before or during sintering; and sintering the gel coating to form a strain tolerant coating. The coating can be a thermal barrier coating.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for coating a metal substrate, comprising:
disposing a sol coating on a metal substrate;
inducing the sol coating to convert to a gel coating;
inducing a pattern on or in the gel coating; and
sintering the gel coating to form a strain tolerant coating.

2. The method of claim 1, further comprising disposing a metallic bond coating on the metal substrate, wherein the sol coating is disposed on the metallic bond coating surface opposite to the metal substrate.

3. The method of claim 2, further comprising drying the gel coating after inducing a pattern on or in the gel coating.

4. The method of claim 1, wherein the sol coating comprises a polymer suspension and ceramic powder solids.

5. The method of claim 1, wherein the sol coating
i) is prepared from one or more metal alkoxide precursors according to the general formula
M(OR¹ₙ)R²₄₋ₙ
wherein each M is independently silicon, titanium, or zirconium; each R¹ is independently a lower alkyl group; each R² is independently a lower alkyl group or a phenyl group optionally substituted with one or more lower alkyl groups; and n is 1, 2, 3, or 4; or
ii) comprises hydrated oxide sols of zirconium (IV), indium (III), gallium (III), iron (III), aluminum (III), chromium (III), cerium (IV), silicon (IV), titanium (IV), and combinations comprising at least one of the foregoing.

6. The method of claim 5, wherein the sol coating further comprises at least one metal selected from the group consisting of Al, Pb, Ca, Sr, Ba, La, Rb, Ag, Au, Cd, Na, Mg, Li, K, Sc, V, Cr, Mn, Fe, Co, Y, Nb, In, Hf, Ta, W, Ce, Pr, Nd, Sm, Eu, Gd, Tb, Dy, Ho, Er, Tm, Yb, Lu, Th, U, Ni, Cu, Zn, As, Ga, Ge, Ru, Sn and combinations comprising at least one of the foregoing.

7. The method of claim 1, wherein the disposing of the sol coating on the metal substrate comprises dip coating, spray coating, roll coating, inkjet printing, spin coating, painting, or a combination comprising at least one of the foregoing methods.

8. The method of claim 1, wherein inducing the sol coating to convert to a gel coating comprises removing volatile components of the sol coating.

9. The method of claim 1, wherein the inducing a pattern on or in the gel coating comprises mechanical, thermal, or chemical methods.

10. The method of claim 9, wherein the mechanical method of inducing a pattern on or in the gel coating comprises scratching; imprinting; screening; cutting; applying a removable, non-wetting pattern or mesh; or combinations comprising at least one of the foregoing.

11. The method of claim 9, wherein the chemical method of inducing a pattern on or in the gel coating comprises application of a non-wetting pattern or inclusion of a binder to result in controlled cracking of the gel coating during drying or sintering.

12. The method of claim 9, wherein the thermal method of inducing a pattern on or in the gel coating comprises laser etching or electron beam etching.

13. The method of claim 1, wherein prior to, or during the act of sintering, the gel coating is hot-isostatically pressed.

14. The method of claim 1, wherein sintering the gel coating is performed at temperatures of about 750° C. to about 1800° C.

15. The method of claim 2, wherein disposing the metallic bond coating comprises vapor deposition, electroplating, ion plasma deposition, plasma spray, thermal deposition or combinations comprising at least one of the foregoing of metallic bond coating elements onto the metal substrate.

16. The method of claim 15, wherein the disposing comprises high velocity oxy-fuel flame spraying or vacuum plasma spray.

17. The method of claim 2, wherein the metallic bond coating comprises MCrAlY, wherein M is selected from the group consisting of nickel, cobalt, iron, and combinations comprising at least one of the foregoing.

18. The method of claim 17, wherein the metallic bond coating further comprises an element selected from the group consisting of silicon, ruthenium, iridium, osmium, gold, silver, tantalum, palladium, rhenium, hafnium, platinum, rhodium, tungsten, alloys comprising at least one of the foregoing, and combinations comprising at least one of the foregoing.

19. The method of claim 1, further comprising forming the coating into a thermal barrier coating.

20. The method of claim 19, wherein the strain tolerant thermal barrier coating has a thickness of about 250 micrometers to about 400 micrometers.

21. The method of claim 1, further comprising forming the coating on a turbine engine component.

22. A method for coating a metal substrate, comprising:
disposing a metallic bond coating on a metal substrate;
disposing a sol coating on the metallic bond coating to the surface opposite to the metal substrate;
inducing the sol coating to convert to a gel coating;
inducing a pattern on or in the gel coating to form a patterned gel coating; hot-isostatically pressing the patterned gel coating; and
sintering the gel coating to form a strain tolerant coating.

23. The method of claim 22, further comprising forming the coating into a thermal barrier coating.
